(19) United States
(12) Patent Application Publication
(10) Pub. No.: US 2006/0242872 A1
(43) Pub. Date: Nov. 2, 2006

(54) VEHICLE-MOUNTED BROCHURE HOLDER

(75) Inventor: Jeremy Lonsk, Edison, NJ (US)

Correspondence Address: LERNER, DAVID, LITTENBERG,;KRUMHOLZ & MENTLIK, 600 SOUTH AVENUE WEST, WESTFIELD, NJ, 07090, US

(73) Assignee: Coyne Communications, Morristown, NJ (US)

(21) Appl. No.: 11/118,743

(22) Filed: Apr. 29, 2005

(51) Int. Cl. G09F 21/04

(52) U.S. Cl. 40/591

(57) ABSTRACT

A brochure holder adapted to be mounted to the license plate mounting holes of a motor vehicle. The brochure holder may contain brochures or other marketing materials relating to the vehicle itself or various options available for the vehicle. The brochure holder is useful in motor vehicle dealerships, auto shows, and other places where vehicles are exhibited where space provided for dissemination of information is limited. The brochure holder may be mounted on a car, truck, motorcycle, or any other motor vehicle.

### BACKGROUND OF THE INVENTION

The present invention relates to brochure holders, and more particularly, to a brochure holder adapted to be mounted to the license plate fastener receiving holes of a vehicle.

When new motor vehicles such as cars and trucks are sold there are many options available with the vehicles. Some of these options may be made by vendors other than the maker and seller of the car. For example, the vehicle may be available with a stereo system made by Bose or upholstery covered with a DuPont stain-resistant coating. Outside vendors find it very difficult to provide information concerning their available products to potential buyers of vehicles because the limited space available for brochure distribution in showrooms and auto shows is taken up by the makers of the vehicles. These outside vendors are constantly looking for new ways to provide information to potential buyers of vehicles concerning the various options available for each vehicle.

Due to the limited space available in showrooms at car dealers and auto shows, car makers and dealers are not able to display every model of every vehicle that they offer. Therefore most car dealers display a few vehicles and provide brochures to potential buyers with information concerning the other models and vehicles available.

In vehicle showrooms at car dealers and at auto shows, it is difficult to create a proper location for the distribution of brochures. Showrooms are of limited size and the vehicles themselves take up a large amout of space. The dealers must also provide wide walkways around the vehicles so that potential buyers can view the vehicles from all angles and walk all the way around the vehicles. It is also necessary to provide meeting areas so that potential buyers may sit and meet with the salesperson to discuss the vehicle. All of this leaves little room for brochure areas.

One attempted solution to this problem has been a standing brochure holder. This method has proven cumbersome because they take up too much space and are frequently knocked over in showrooms. At auto shows, placing a standing brochure holder close to a vehicle inhibits the view of the vehicle, while placing the brochure holder further away makes it difficult to locate.

Another attempted solution has been to locate brochure holders on the hood or trunk of the vehicle, or even inside the vehicle itself. However, this method inhibits the ability to view the contours and spaciousness of the vehicle.

Therefore there is a need for a brochure holder that can provide information to potential buyers at showrooms and auto shows that does not require extra space and does not alter the look of the vehicle.

### SUMMARY OF THE INVENTION

The present invention is directed to a brochure holder adapted to be mounted to the license plate fastener receiving holes of a vehicle.

In a preferred embodiment, a brochure holder according to the present invention comprises a receptacle for mounting to a vehicle having fastener-receiving holes, the receptacle comprising a rear member having apertures adapted to line up with the fastener-receiving holes of a vehicle, a front member, and a bottom member connecting the rear member and the front member to create an opening therebetween. The rear member is preferably substantially the same size as a license plate. The front member of the receptacle may extend to a height below the height of the rear member. The receptacle is preferably made of plastic. The front member of the receptacle may be curved in such a way as to connect directly to the rear member. The receptacle may also include a pair of spaced apart side members connecting the front member to the rear member. The receptacle may be connected to a plurality of vehicles, such as an automobile. The rear member, front member, and bottom member may form a U-shaped member.

In an alternate embodiment, the present invention comprises a receptacle for mounting to a vehicle having fastener-receiving holes, the receptacle comprising a rear member having pins adapted to line up with the fastener-receiving holes of a vehicle, a front member, and a bottom member connecting the rear member and the front member to create an opening therebetween. The rear member is preferably substantially the same size as a license plate. The front member may extend to a height below the height of the rear member. The receptacle is preferably made of plastic. The front member of the receptacle may be curved so that it connects directly to the rear member. Alternatively, the receptacle may include a pair of spaced apart side members connecting the front member to the rear member. The receptacle may be connected to a plurality of vehicles, such as an automobile. The rear member, front member, and bottom member of the receptacle may form a U-shaped member.

In a method according to the present invention, a receptacle comprising a rear member having apertures, a front member, and a bottom member connecting the rear member and the front member to create an opening therebetween is attached to a vehicle having fastener-receiving holes, the method comprising aligning the apertures of the rear member with the fastener-receiving holes of the vehicle and attaching the receptacle to the receiving holes on the vehicle. The method may also include inserting at least one fastener into the fastener-receiving holes.

### BRIEF DESCRIPTION OF THE DRAWINGS

FIG. 1 is a front elevational view of a preferred embodiment of a brochure holder according to the present invention.

FIG. 2 is an elevational view of the brochure holder of FIG. 1 as attached to the rear of a vehicle.

FIG. 3 is an elevational view of the brochure holder of FIG. 1 as attached to the front of a vehicle.

FIG. 4 is a side elevational view of the brochure holder of FIG. 1 as attached to the front of a vehicle.

FIG. 5 is a front elevational view of an alternate embodiment of a brochure holder according the present invention.

FIG. 6 is a side elevational view of an alternate embodiment of a brochure holder according to the present invention.

FIG. 7 is an elevational view of an alternate embodiment of a brochure holder according to the present invention as attached to the rear of a motorcycle.

### DETAILED DESCRIPTION

The present invention provides a way for motor vehicle manufacturers and outside vendors to provide information to potential customers by attaching a brochure holder to the license plate receiving holes of a vehicle.

The present invention takes advantage of an area that is available on every motor vehicle but has heretofore gone unused in the marketing and sale of motor vehicles. The automobile industry has set a standard for the size of license plates, and motor vehicle manufacturers provides license plate fastener receiving holes on all new vehicles that are to be sold in the United States. Various fasteners may be used, such as screws, bolts, plastic plugs, and the like. The holes on automobiles are generally about 7″ apart, while the holes on motorcycles are generally about 5¾ inches apart. These holes are substantially uniform regardless of the vehicle. These holes and the space provided for license plates on vehicles go unused in showrooms and at auto shows because the vehicles do not need license plates until they have been sold and registered. Using these holes, a brochure holder according to the present invention may be mounted on almost any motor vehicle in the United States.

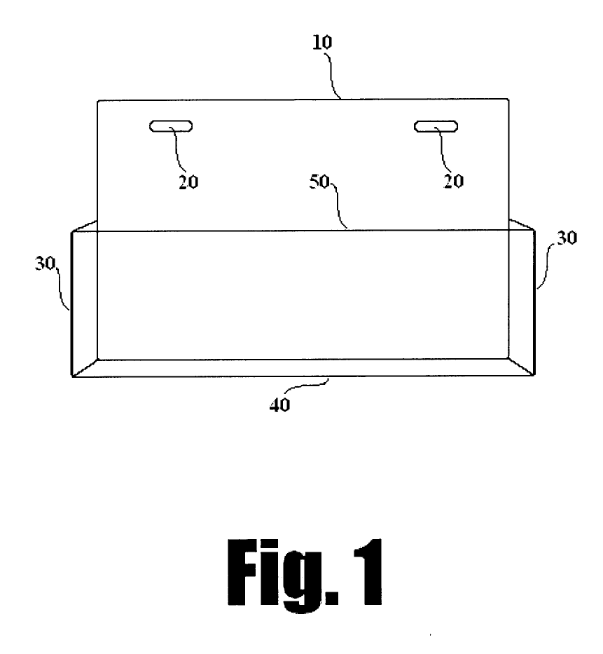

A preferred embodiment of a brochure holder according to the present invention is shown in FIG. 1. The brochure holder preferably has a flat planar rear wall 10 that is about the same size as a standard license plate. The rear wall 10 has two apertures 20 that are spaced apart to match up to the fastener receiving holes on motor vehicles that receive license plate mounting fasteners such as screws. The apertures 20 are preferably elongated as shown in FIG. 1 to accommodate minor deviations in spacing of fastener holes between vehicles.

The brochure holder of FIG. 1 also has two side walls 30 that are perpendicular to the rear wall 10 and extend outwardly from the rear wall 10. The side walls are preferably 2-3 inches wide to accommodate brochures, but they may be made even wider for larger amounts of brochures or for giveaways, such as key chains with a logo on them.

The brochure holder of FIG. 1 also has a bottom member 40 and a front wall 50 which form an enclosure for holding brochures. The rear wall 10 extends to a height above the side walls 30 and front wall 50 for ease of installation and so that brochures that are the size of the rear wall protrude from the holder. One skilled in the art would recognize that there are many possible variations to the embodiment of FIG. 1, such providing small ridged pegs that fit into the fastener receiving holes of a vehicle for attaching the brochure holder to a vehicle.

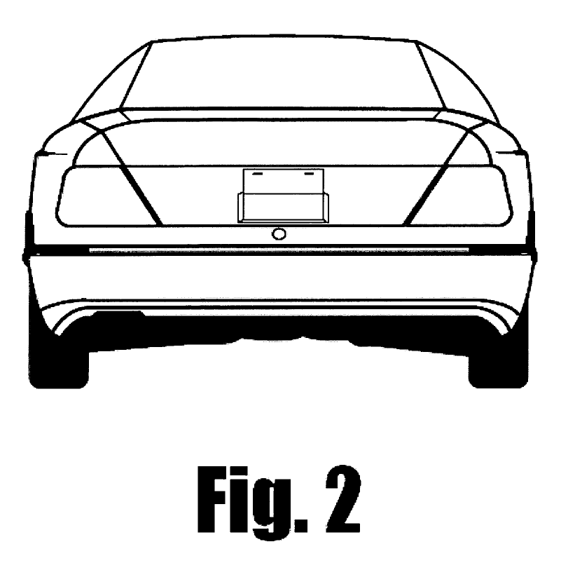

FIG. 2 shows a preferred embodiment of the brochure holder attached to the rear of a vehicle. It is apparent from FIG. 2 how the brochure holder creates a space for the dissemination of information concerning the vehicle itself or options for the vehicle without inhibiting the contours of the vehicle. Potential buyers are still able to view the entire vehicle and may obtain additional information without looking any further than the vehicle itself. The brochure holder also allows potential buyers to walk freely around the vehicle. Brochures that may go unnoticed in the corner of a dealership or auto show are now placed squarely in the view of potential buyers.

For example, a brochure concerning satellite radio may be placed in the brochure holder in such a way that the top of the brochure says “This vehicle is available with satellite radio!” When a potential buyer visits the showroom and views the vehicle, they will see the brochure contained in the holder and may take one to read about the satellite radio options available with the vehicle.

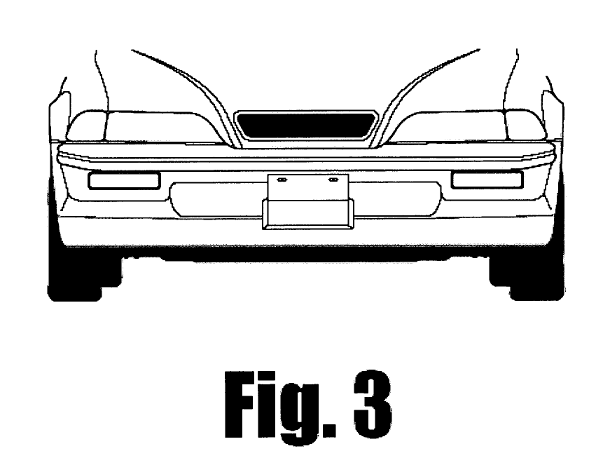

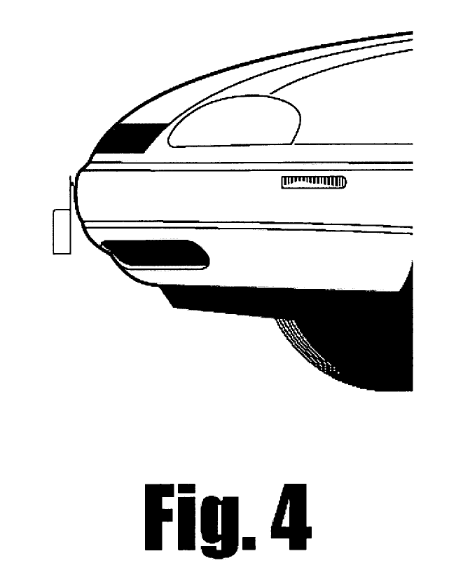

FIGS. 3 and 4 show a preferred embodiment of the brochure holder attached to the front of a vehicle. This view once again clearly shows how the brochure holder does not alter the designed curvature of the vehicle and does not inhibit the flow of people around the vehicle.

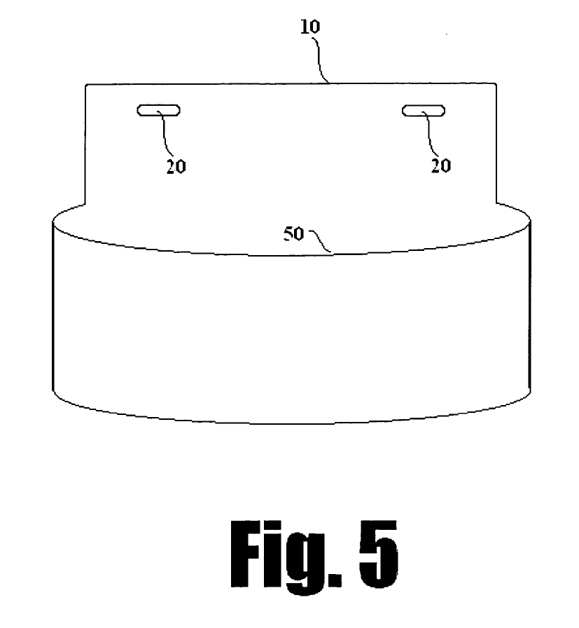

FIG. 5 shows an alternate embodiment of a brochure holder according to the present invention. The brochure holder of FIG. 5 has a flat planar rear wall 10 attached to a curved front wall 50 which forms the side walls. The opening provided by this embodiment is larger than the embodiment depicted in FIG. 1 and may be useful in handing out marketing materials such as free key chains with the vehicle's logo.

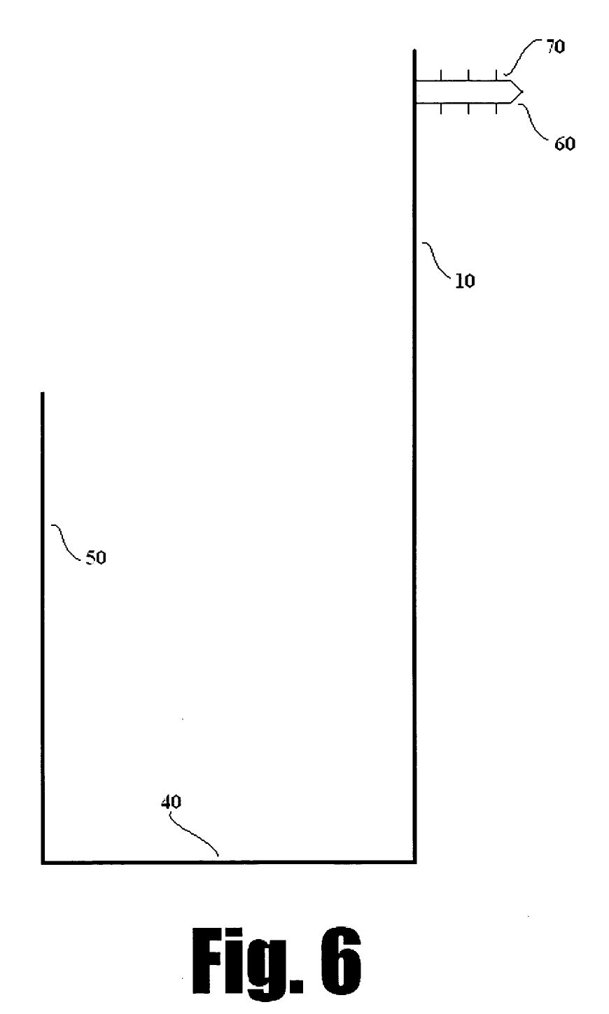

FIG. 6 depicts a side view of an alternate embodiment of the present invention. The brochure holder depicted in FIG. 6 has two pins 60 where the apertures would be in the embodiment described above in connection with FIGS. 1-4. The pins 60 are located approximately seven inches apart to match up to the license plate fastener receiving holes on motor vehicles. The pins 60 preferably include small flexible tines 70 extending outwardly from the pins. This embodiment of the brochure holder is installed on a vehicle simply by aligning the pins 60 with the license plate fastener receiving holes on a vehicle and pushing the brochure holder against the vehicle. When the pins move into the fastener receiving holes, the flexible tines will bend and hold the brochure holder in place. The brochure holder may then be removed by simply pulling the brochure holder away from the vehicle. The pins 60 and flexible tines 70 are preferably made of rubber but may be constructed out of any flexible material, such as a polymer material.

The embodiment depicted in FIG. 6 also has no side walls. This U-shaped embodiment has a bottom wall 40 which connects the front wall 50 to the rear wall 10 in such a way as to create an opening for receiving brochures between the front wall 50 and the rear wall 10.

Although the preferred embodiments depicted in FIGS. 1-6 are designed to have a rear wall roughly the size of a standard United States license plate, one skilled in the art would recognize that the present invention may be utilized with vehicles in other countries. For example, in Great Britain where the license plates are longer and narrower than United States license plates, the brochure holder will have a rear wall and front wall that are longer and narrower to fit where the Great Britain license plate would fit on a vehicle. The apertures would also be spaced apart as necessary to fit the fastener receiving holes on foreign vehicles.

The present invention has been described and depicted as attachable to a car, but it may be easily attached to trucks, trailers, sport utility vehicles, boats, recreational vehicles, and motorcycles.

The brochure holder of the present invention is preferably made of 0.040 clear Polyethylene Terephthalate Copolymer, or PETG. This material is lightweight, strong, glossy, and easy to manufacture. The brochure holder is preferably transparent so that the viewer may see the entire brochure, including the portion of the brochure contained in the holder. In alternate embodiments, the brochure holder may be constructed of other materials, such as metals that match the exterior of a particular vehicle or wood to convey an outdoor theme. The brochure holder also need not be completely solid, it may be made of mesh.

The brochure holder is depicted as clear plastic but may also have a particular company's logo on the outside. For example, a brochure holder attached to a Jeep may say “Jeep” on the front wall. The logo may also be for the particular car dealer or for outside vendors. If the brochure holder contains brochures on a particular car audio option, the brochure holder may have the logo of the outside vendor providing the option. One skilled in the art would recognize that there may be a plurality of different texts or graphics printed on or adhered to the body of the brochure holder.

In one embodiment, the depth of the brochure holder is depicted as the same size as a standard automobile license plate. The depth may be made significantly deeper, however, if the brochure holder is to hold larger brochures.

The brochure holder is preferably attached to a vehicle using the OEM (original equipment manufacturer) screws provided with the vehicle for attaching the license plates of a vehicle. If the vehicle is sold, the brochure holder will be removed and replaced by license plates using the same screws.

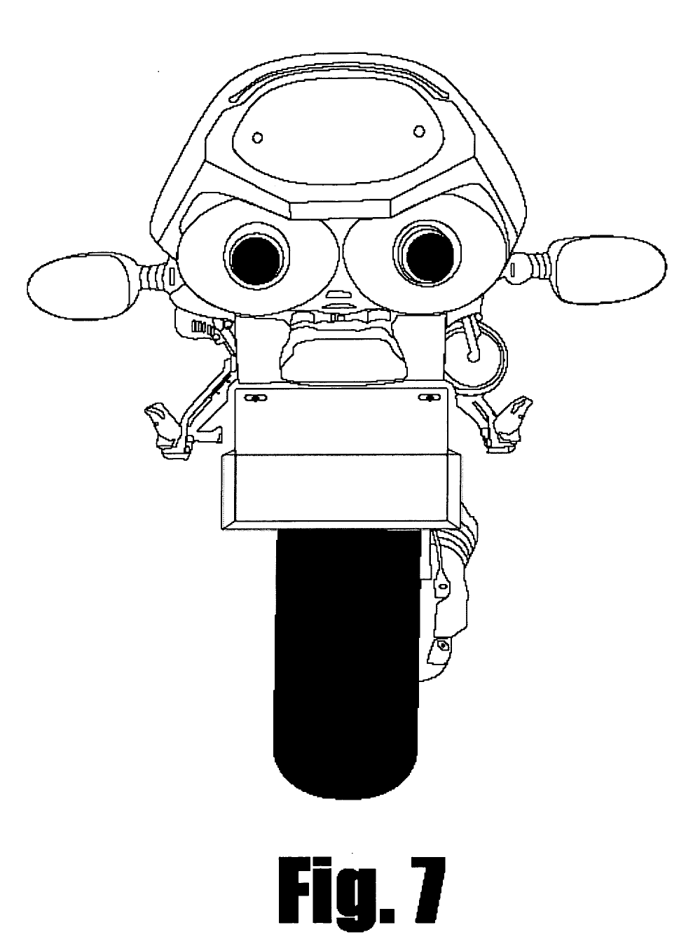

As depicted in FIG. 7, the brochure holder of the present invention may also be adapted to be used on motorcycles. FIG. 7 shows a brochure holder according to the present invention mounted to the rear of a motorcycle using the license plate receiving holes on the motorcycle. The brochure holder will be made considerably smaller to fit the smaller sizes of motorcycle license plates and the apertures of the brochure holder will be closer together to match up to the license plate fastener receiving holes on motorcycles. The brochure holder may also place the fastener receiving holes on an angle to compensate for the lean of a motorcycle when placed on a kickstand in a showroom or motorcycle show.

Although the invention herein has been described with reference to particular embodiments, it is to be understood that these embodiments are merely illustrative of the principles and applications of the present invention. It is therefore to be understood that numerous modifications may be made to the illustrative embodiments and that other arrangements may be devised without departing from the spirit and scope of the present invention as defined by the appended claims.

1. A device for displaying brochures, comprising:
(a) a motor vehicle having a license plate area for holding a license plate,
(b) a receptacle removably attached to the license plate area of motor vehicle comprising:
(i) a rear member having a rear member height and being positioned in the license plate area of the motor vehicle;
(ii) a front member spaced from the rear member and having a front member height sufficient to retain brochures for display, the spacing being sufficient to provide an opening such that when brochures are retained in the receptacle, a single brochure can be removed from the receptacle while leaving others in the receptacle, whereon the front member height is less than the rear member height; and
(iii) a bottom member connecting the rear member and the front member to create the opening therebetween.

2. The receptacle of claim 1, wherein the rear member is substantially the same size as the license plate area.

3. (canceled)

4. The receptacle of claim 1, wherein at least the front member of the receptacle is made of transparent plastic.

5. The receptacle of claim 1, wherein the front member is curved in at least one direction, the front member connecting to the rear member.

6. The receptacle of claim 1, further comprising a pair of spaced apart side members connecting the front member to the rear member.

7. The receptacle of claim 1, wherein the motor vehicle is an automobile.

8. The receptacle of claim 1, wherein the rear member, front member, and bottom member form a substantially U-shaped member.

9. A device for displaying brochures, comprising:
(a) a motor vehicle having a bumper,
(b) a receptacle removably attached to the bumper, the receptacle comprising:
(i) a rear member having a rear member height and being positioned against the bumper;
(ii) a front member spaced from the rear member and having a front member height sufficient to retain brochures for display, the spacing being sufficient to provide an opening such that when brochures are retained in the receptacle, a single brochure can be removed from the receptacle while leaving others in the receptacle, wherein the front member height is less than the rear member height; and
(iii) a bottom member connecting the rear member and the front member to create the opening therebetween.

10. (canceled)

11. (canceled)

12. The receptacle of claim 9, wherein the receptacle is made of transparent plastic.

13. The receptacle of claim 9, wherein the front member is curved in at least one direction, the front member connecting to the rear member.

14. The receptacle of claim 9, further comprising a pair of spaced apart side members connecting the front member to the rear member.

15. The receptacle of claim 9, wherein the motor vehicle is an automobile.

16. The receptacle of claim 9, wherein the rear member, front member, and bottom member form a U-shaped member.

17-22. (canceled)
